(19) United States
(12) Patent Application Publication
(10) Pub. No.: US 2016/0364980 A1
(43) Pub. Date: Dec. 15, 2016

(54) Extender Rod

(71) Applicants: Monica Mckee, Laplace, LA (US); Tyrone Bell, New Orleans, LA (US)

(72) Inventors: Monica Mckee, Laplace, LA (US); Tyrone Bell, New Orleans, LA (US)

(21) Appl. No.: 14/737,955

(22) Filed: Jun. 12, 2015

(51) Int. Cl. G08C 17/02; F16M 13/02; F16C 3/03

(52) U.S. Cl. CPC G08C 17/02; F16C 3/03; F16M 13/027; G08C 2201/30

(57) ABSTRACT

Disclosed herein is a remotely controllable suspension fixture extension system used to suspend an object from a support for easy reachability of said object and safety of a user, wherein the system comprises of a telescopic rod assembly attached with said suspended object, further comprises of an outside rod, a middle rod and an inner rod, housed inside each other; a remote controlling device which comprises of a control panel providing a plurality of buttons to control the movement of said telescopic rod assembly, a power button to turn on and/or turn of said remote controlling device and a logo; an indicating system attached to said telescopic rod assembly to indicate the connection between said telescopic rod assembly and said remote control device; and a sensory system attached to said telescopic rod assembly to restricts the functioning of said object on said extension of said middle rod.

### CROSS REFERENCE TO RELATED APPLICATIONS

Not applicable.

### FEDERALLY SPONSORED RESEARCH AND DEVELOPMENT

Not applicable.

### MICROFICHE

Not applicable

### BACKGROUND OF THE INVENTION

(1) Field of the Invention

The disclosure relates in general to a remotely operated device, and more particularly, to a remote control improved extension tool assembly for user convenience for the arrangement of certain home appliances like fan etc.

(2) Background

Ceiling fixtures are commonly used in a variety of residential and commercial locations today. These fixtures encompass a variety of uses, from lighting an area to circulating air within a room, and are generally placed in the center of a ceiling or upper wall. Many ceiling fixtures contain light bulbs that must be regularly changed or fan blades that require periodic cleaning. This often requires the use of a ladder or similar device to reach and service the ceiling fixture. Once an individual climbs a ladder, that person has to be prepared to move in awkward positions while trying to balance on a ladder creating a safety concern. In the past there has been a strong desire to recess and conceal various types of audio visual equipment within the confines of a room or vehicle which is used for presentations. While some projectors are mounted permanently on structures within the room, others in more sophisticated settings have been concealed or hidden in the walls, floor or ceiling of the structure. Similarly, if the fixture encompasses more than a light bulb, multiple trips up and down the ladder, possibly with additional equipment, may be needed to service the unit. For example, cleaning or maintaining a ceiling fan may require carrying up extra cleaning implements, extra ceiling blades or tools to service electrical components. Furthermore, it is often quite difficult to clean some intricate lighting displays, or even small crevices in the ceiling units. Moreover, in the case of extremely tall rooms control of the unit is inconvenient. For example, a typical placement of ceiling fans is to be as high as possible. However, placing the fan at such a height makes controlling fan speeds through a typical pull chain unsightly and inconvenient. Additionally, if more direct circulation is needed, a user may wish to lower the fan height depending on ambient conditions. Similarly, a user may wish to control the focus of light through raising or lowering the lighting fixture. However, there is no way to control such heights without going through complicated and very time consuming steps to replace the pole connecting the fixture to the ceiling. Also, using ladders can be extremely dangerous. Many individuals have fallen from ladders when changing light bulbs or cleaning ceiling fans. And, in some homes, the ceilings are so high it is almost impossible to reach ceiling fans and light bulbs with traditional ladders. The present invention features a novel system for raising and lowering ceiling fans and ceiling lights, allowing for easy, safe, and ladder-free cleaning. Further, traditional outdoor lamp pole system such as street light, parking light, area light, and landscaping light system installs light source and control gear inside a lighting fixture mounted at the top or the upper part of a lamp pole or column. This consumes a lot of time and resources to hire truck-mounted elevators for regular inspection, maintenance and lamp replacement. The affected streets, road lanes, and surrounding areas have to be temporarily blocked. These inspections, maintenance and replacement works are likely to cause serious traffic disruption. In addition, many fixtures such as ceiling fans have controls and switches that are difficult, if not impossible to see, without being on a ladder. As such, operation and maintenance of these types of ceiling fixtures are at best inconvenient and not properly maintained, and at worst, dangerous due to the use of ladders.

### BRIEF SUMMARY OF THE INVENTION

The primary objective of the invention is providing a remotely controllable suspension fixture extension system used to suspend an object from a support. The system comprises of a telescopic rod assembly, a remote controlling device to adjust extension and retraction of said remotely controllable suspension fixture and a means to control said telescopic rod assembly using said remote controlling device. The remote controlled system adjusts the extension and retraction of a suspension means used to suspend an object like a ceiling fan from a support. The plurality of rods of the telescopic rod assembly which comprises of an outside rod, a middle rod and an inner rod is housed inside each other, also the outside rod, the middle rod is hollow and the middle rod extends to the length of the inner rod. Also the remote controlling device controls the movement of the rod assembly to extend and retract and further comprises of a button to turn on and/or turn off said remote controlling device, a control panel with a plurality of buttons to control the movement of the telescopic rod assembly and a logo. The control panel of the remote control device can also be on a touch interface.

In a preferred embodiment of the invention the system comprises of a light indicator that is attached to the telescopic rod assembly to indicate a connection of the rod assembly with a remote controlling device and a sensory device to senses the movement of the assembly to extend and retracts and disconnects the flow of electricity to the object.

In one embodiment the invention is remote controlled system to displace a suspended object for easy reachability of said object and safety of a user. The system comprises of a telescopic rod assembly attached with said suspended object, further comprises of an outside rod, a middle rod and an inner rod, housed inside each other, wherein said outside rod and said middle rod are hollow and said middle rod extends to the length of said inner rod.

Further in the same embodiment the system comprises of a remote controlling device which comprises of a control panel providing a plurality of buttons to control the movement of said telescopic rod assembly, a power button to turn on and/or turn of said remote controlling device and a logo; an indicating system attached to said telescopic rod assembly to indicate the connection between said telescopic rod assembly and said remote control device and a sensory system attached to said telescopic rod assembly to restricts the functioning of said object on said extension of said middle rod.

The summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 illustrates the prospective view of the invention identifying different components of the invention and their working.

### DETAILED DESCRIPTIONS OF THE INVENTION

The following is a detailed description of example embodiments of the invention depicted in the accompanying drawings. The example embodiments are in such detail as to clearly communicate the invention. However, the amount of detail offered is not intended to limit the anticipated variations of embodiments; but, on the contrary, the intention is to cover all modifications, equivalents, and alternatives falling within the spirit and scope of the present invention as defined by the appended claims. The detailed descriptions below are designed to make such embodiments obvious to a person of ordinary skill in the art.

The present invention aims to provide a remote controlled system to adjust deprivation or elevation of an object suspended from a support, further the system is a means to displace the object attached to it for the easy reachability of the object and safety of the user, also in one embodiment of the invention the system aims to provide a means wherein users no longer would need to climb a ladder to fix a ceiling fan or a light bulb or position a projector etc.

The primary objective of the invention is providing a remotely controllable suspension fixture extension system used to suspend an object from a support. The system comprises of a telescopic rod assembly, a remote controlling device to adjust extension and retraction of said remotely controllable suspension fixture and a means to control said telescopic rod assembly using said remote controlling device. The remote controlled system adjusts the extension and retraction of a suspension means used to suspend an object like a ceiling fan from a support. The plurality of rods of the telescopic rod assembly which comprises of an outside rod, a middle rod and an inner rod is housed inside each other, also the outside rod, the middle rod is hollow and the middle rod extends to the length of the inner rod. Also the remote controlling device controls the movement of the rod assembly to extend and retract and further comprises of a button to turn on and/or turn off said remote controlling device, a control panel with a plurality of buttons to control the movement of the telescopic rod assembly and a logo. The control panel of the remote control device can also be on a touch interface

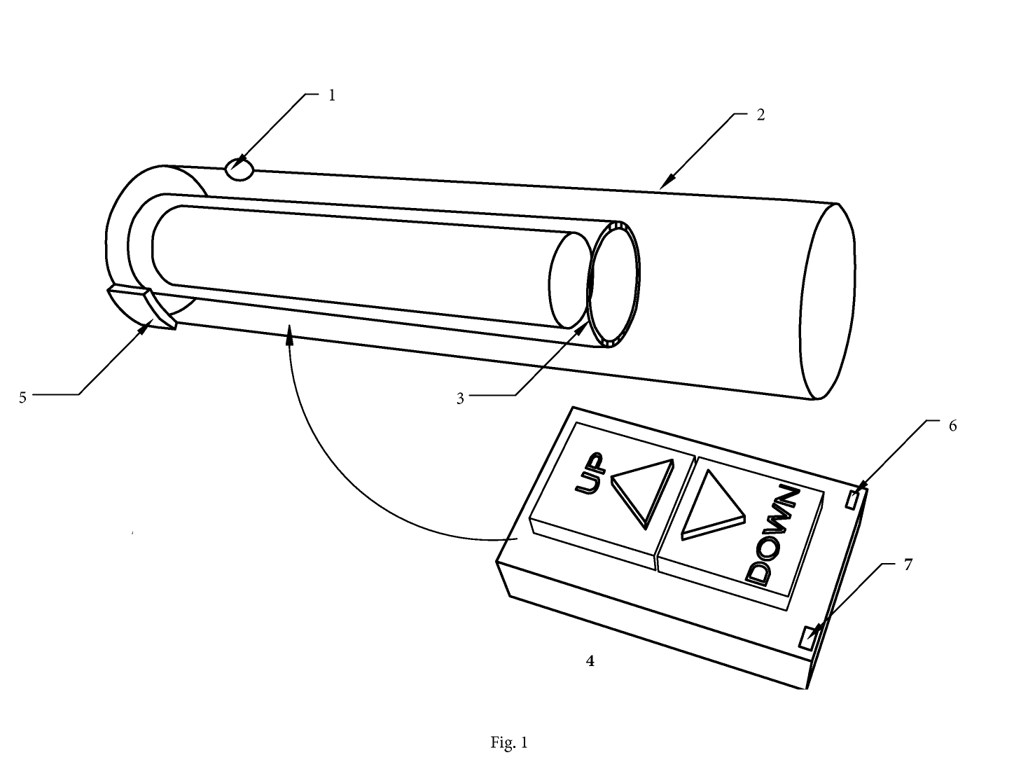

Referring to the drawings, and specifically to FIG. 1 thereof, is shown the rod assembly, wherein a plurality of rods is housed inside each other in a manner that the rod in at the center of the housing arrangement extends the attached object to the furthest distance.

The FIG. 1 of the drawing also illustrates a light indicator 1 that is attached to the telescopic rod assembly 2 with extended rod 3 to indicate a connection of the rod assembly with a remote controlling device 4 and a sensory device 5 to senses the movement of the assembly to extend and retract and disconnects the flow of electricity to the object. Also the placement of the light indicator that indicates the established connection between the rod assembly and the remote is shown and the sensor that enables the device to sense the displacement in the rod assembly, to disconnect the flow of electricity to the object so that it stops to function.

Further, referring to FIG. 1 of the drawings is shown, a remote controlling device which comprises of a control panel providing a plurality of buttons to control the movement of said telescopic rod assembly, a power button 6 to turn on and/or turn of said remote controlling device and a logo 7; an indicating system attached to said telescopic rod assembly to indicate the connection between said telescopic rod assembly and said remote control device and a sensory system attached to said telescopic rod assembly to restricts the functioning of said object on said extension of said middle rod. Also the remote controlled device that would enable the user to control the rod assembly. The figure displays the placing of the up and down buttons to enable the displacement functionality of the rod assembly and the power button on the remote control to turn on the remote control.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

Although the invention has been explained in relation to its preferred embodiment, it is to be understood that many other possible modifications and variations can be made without departing from the spirit and scope of the invention.

We claim:

1. A remotely controllable suspension fixture extension system used to suspend an object from a support, system comprising:
a telescopic rod assembly;
a remote controlling device to adjust extension and retraction of said remotely controllable suspension fixture; and
a means to control said telescopic rod assembly using said remote controlling device.

2. The remotely controllable suspension fixture extension system as set forth in claim 1, wherein said telescopic rod assembly further comprises of a plurality of rods housed inside each other.

3. The remotely controllable suspension fixture extension system as set forth in claim 1, wherein said plurality of rods housed inside each other of said telescopic rod assembly further comprises of an outside rod, a middle rod and an inner rod.

4. The remotely controllable suspension fixture extension system as set forth in claim 1, wherein said outside rod and said middle rod of said telescopic rod assembly is hollow.

5. The remotely controllable suspension fixture extension system as set forth in claim 1, wherein said middle rod of said telescopic rod assembly extends to a length of said inner rod.

6. The remotely controllable suspension fixture extension system as set forth in claim 1, wherein an indicator is attached to said telescopic rod assembly to indicate a connection of said rod assembly with said remote controlling device.

7. The remotely controllable suspension fixture extension system as set forth in claim 1, wherein said indicator attached to said telescopic rod assembly to indicate said connection of said rod assembly with said remote controlling device is a light indicator.

8. The remotely controllable suspension fixture extension system as set forth in claim 1, wherein said telescopic rod assembly further comprises of a sensory device.

9. The remotely controllable suspension fixture extension system as set forth in claim 1, wherein said sensory device attached to said telescopic rod assembly restricts functioning of said object on said extension of said middle rod.

10. The remotely controllable suspension fixture extension system as set forth in claim 1, wherein said remote controlling device further comprises of a means to turn on and/or turn off said remote controlling device, a logo and a means to control movement of said telescopic rod assembly.

11. The remotely controllable suspension fixture extension system as set forth in claim 1, wherein said means to turn on and/or turn off said remote controlling device is a power button.

12. The remotely controllable suspension fixture extension system as set forth in claim 1, wherein said means to control movement of said telescopic rod assembly is a plurality of buttons.

13. The remotely controllable suspension fixture extension system as set forth in claim 1, wherein said plurality of buttons providing said means to control movement of said telescopic rod assembly further comprises of a button to suspend said middle rod of said telescopic rod assembly and a button to rise said extender middle rod of said telescopic rod assembly.

14. The remotely controllable suspension fixture extension system as set forth in claim 1, wherein said means to control movement of said telescopic rod assembly is a digital touch screen interface with a plurality of buttons.

15. The remotely controllable suspension fixture extension system as set forth in claim 1, wherein said digital touch screen interface with a plurality of buttons providing said means to control said movement of said telescopic rod assembly further comprises of a button to suspend said middle rod of said telescopic rod assembly and a button to rise said extender middle rod of said telescopic rod assembly.

16. A remote controlled system to displace an suspended object for easy reachability of said object and safety of a user, system comprising:
a telescopic rod assembly attached with said suspended object, further comprises of an outside rod, a middle rod and an inner rod, housed inside each other, wherein said outside rod and said middle rod are hollow and said middle rod extends to the length of said inner rod;
a remote controlling device which comprises of a control panel providing a plurality of buttons to control movement of said telescopic rod assembly, a power button to turn on and/or turn of said remote controlling device and a logo;
an indicating system attached to said telescopic rod assembly to indicate the connection between said telescopic rod assembly and said remote control device; and
a sensory system attached to said telescopic rod assembly to restricts the functioning of said object on said extension of said middle rod.
